(19) United States
(12) Patent Application Publication
(10) Pub. No.: US 2026/0243896 A1
(43) Pub. Date: Aug. 20, 2026

(54) ELECTROMAGNETIC WAVE DETECTION DEVICE, ELECTROMAGNETIC WAVE DETECTION METHOD, PROGRAM, AND MOBILE BODY

(71) Applicant: KYOCERA Corporation, Kyoto (JP)

(72) Inventor: Hiroki OKADA, Machida-shi, Tokyo (JP)

(73) Assignee: KYOCERA Corporation, Kyoto (JP)

(21) Appl. No.: 19/489,581

(22) PCT Filed: Jun. 4, 2024
(86) PCT No.: PCT/JP2024/020424

§ 371 Date: Dec. 2, 2025

(30) Foreign Application Priority Data
Jun. 29, 2023 (JP) 2023-106927

(51) Int. Cl. G01S 17/42; G01S 17/89

(52) U.S. Cl. CPC G01S 17/42; G01S 17/89

(57) ABSTRACT

An electromagnetic wave detection device (10) includes: a radiation unit (12) configured to output electromagnetic waves to be radiated onto an area including a first area; a first detection unit (20) configured to detect reflected waves resulting from the electromagnetic waves being reflected by the first area; and a controller (14) configured to execute specific position calculation processing to, based on a distance acquired based on the detected reflected waves, a direction in which the electromagnetic waves are radiated, and a factor affecting a reflectance of the electromagnetic waves in the first area, calculate a specific position in the first area corresponding to the distance.

### CROSS-REFERENCE TO RELATED APPLICATIONS

This application claims priority of Japanese Patent Application No. 2023-106927 (filed Jun. 29, 2023), the entire disclosure of which is hereby incorporated by reference.

### TECHNICAL FIELD

The present disclosure relates to an electromagnetic wave detection device, an electromagnetic wave detection method, a program, and a mobile body.

### BACKGROUND OF INVENTION

In recent years, devices have been developed for detecting electromagnetic waves in order to obtain information about the surrounding area from the detection results. For example, Patent Literature 1 discloses a technology for detecting objects (such as obstacles) on a road using LiDAR (light detection and ranging).

### CITATION LIST

### Patent Literature

Patent Literature 1: International Publication No. 2019/026715

### SUMMARY

(1) In an embodiment of the present disclosure, an electromagnetic wave detection device includes a radiation unit, a first detection unit, and a controller.
The radiation unit is configured to output electromagnetic waves to be radiated onto an area including a first area.
The first detection unit is configured to detect reflected waves resulting from the electromagnetic waves being reflected by the first area.
The controller is configured to execute specific position calculation processing to, based on a distance acquired based on the detected reflected waves, a direction in which the electromagnetic waves are radiated, and a factor affecting a reflectance of the electromagnetic waves in the first area, calculate a specific position in the first area corresponding to the distance.
(2) As an embodiment of the present disclosure, in (1),
the electromagnetic wave detection device further includes a deflection unit configured to change a radiation direction of the electromagnetic waves output by the radiation unit.
(3) As an embodiment of the present disclosure, in (1) or (2),
the electromagnetic wave detection device further includes a second detection unit configured to capture an image of the area including the first area, and
the controller acquires the factor affecting the reflectance of the electromagnetic waves from the captured image of the first area.
(4) As an embodiment of the present disclosure, in (3),
the controller acquires the factor affecting the reflectance of the electromagnetic waves based on luminance information in the image of the first area.
(5) As an embodiment of the present disclosure, in (4),
the controller calculates the specific position based on a center position in the image of the first area and a position of a luminance centroid of the image.
(6) As an embodiment of the present disclosure, in any of (1) to (5),
the factor affecting the reflectance of the electromagnetic waves is a presence of areas in the first area with different reflectances for the electromagnetic waves.
(7) As an embodiment of the present disclosure, in any one of (1) to (6),
the specific position calculation processing is executed when a distance to the first area is greater than or equal to a predetermined distance.
(8) As an embodiment of the present disclosure, in any one of (1) to (7),
the specific position calculation processing is executed when an incidence angle with respect to the first area is less than a predetermined angle.
(9) In an embodiment of the present disclosure, an electromagnetic wave detection device includes a radiation unit, a first detection unit, and a controller.
The radiation unit is configured to output electromagnetic waves to be radiated onto an area including a first area.
The first detection unit is configured to detect reflected waves resulting from the electromagnetic waves being reflected by the first area.
The controller is configured to execute specific position calculation processing to, based on a distance to the first area acquired based on the detected reflected waves, a direction in which the electromagnetic waves are radiated, and a color of an object present in the first area, calculate a specific position in the first area corresponding to the distance.

(10) In an embodiment of the present disclosure, an electromagnetic wave detection device includes a radiation unit, a first detection unit, and a controller.
The radiation unit is configured to output electromagnetic waves to be radiated onto an area including a first area.
The first detection unit is configured to detect reflected waves resulting from the electromagnetic waves being reflected by the first area.
The controller is configured to execute specific position calculation processing to, based on a distance to the first area acquired based on the detected reflected waves, a direction in which the electromagnetic waves are radiated, and a reflectance of an object present in the first area, calculate a specific position in the first area corresponding to the distance.

(11) In an embodiment of the present disclosure, an electromagnetic wave detection method includes:
irradiating an area including a first area with electromagnetic waves;
detecting reflected waves resulting from the electromagnetic waves being reflected by the first area; and
executing specific position calculation processing to, based on a distance to the first area calculated based on the detected reflected waves, a direction to the first area, and a factor affecting a reflectance of the electromagnetic waves in the first area, calculate a specific position in the first area corresponding to the distance.
(12) In an embodiment of the present disclosure, a program is configured to, based on a distance to a first area acquired based on reflected waves resulting from electromagnetic waves radiated by a radiation unit being reflected by the first area, a direction in which the electromagnetic waves are radiated, and a factor affecting a reflectance of the electromagnetic waves in the first area, calculate a specific position in the first area corresponding to the distance.
(13) In an embodiment of the present disclosure, a program is configured to, based on a distance to a first area acquired based on reflected waves resulting from electromagnetic waves radiated by a radiation unit being reflected by the first area, a direction in which the electromagnetic waves are radiated, and a color of an object present in the first area, calculate a specific position in the first area corresponding to the distance.
(14) In an embodiment of the present disclosure, a program is configured to, based on a distance to a first area acquired based on reflected waves resulting from electromagnetic waves radiated by a radiation unit being reflected by the first area, a direction in which the electromagnetic waves are radiated, and a reflectance of an object present in the first area, calculate a specific position in the first area corresponding to the distance.
(15) In an embodiment of the present disclosure, a mobile body includes
the electromagnetic wave detection device of (1), (9), or (10) installed therein.
(16) As an embodiment of the present disclosure, in (15),
the mobile body is a vehicle, and
the first area is a portion of a road or road surface on which the vehicle travels.
(17) As an embodiment of the present disclosure, in (15),
the mobile body is a ship, and
the first area is a portion of a quay where the ship docks.
(18) As an embodiment of the present disclosure, in (15),
the mobile body is a railway vehicle, and
the first area is a portion of a track on which the railway vehicle travels.
(19) As an embodiment of the present disclosure, in (15),
the mobile body is an aircraft, and
the first area is a portion of a runway surface on which the aircraft travels.

### BRIEF DESCRIPTION OF THE DRAWINGS

FIG. 1 is a configuration diagram illustrating the schematic configuration of an electromagnetic wave detection device according to an embodiment of the present disclosure.

FIG. 2 is a diagram for explaining a propagation direction of electromagnetic waves in a first state and a second state of the electromagnetic wave detection device in FIG. 1.

FIG. 3 is a diagram for explaining the detection of electromagnetic waves including reflected waves.

FIG. 4 is a timing chart for explaining calculation of distances.

FIG. 5 is a diagram illustrating an example of LiDAR pixels.

FIG. 6 is a diagram for explaining differences in distance that may occur depending on LiDAR pixels.

FIG. 7 is a diagram for explaining a specific position.

FIG. 8 is a diagram for explaining calculation of the coordinates of a specific position.

FIG. 9 is a diagram for explaining correction performed for each LiDAR pixel.

FIG. 10 is a diagram for explaining an execution condition for specific position calculation processing.

FIG. 11 is a diagram for explaining an execution condition for specific position calculation processing.

FIG. 12 is a flowchart illustrating the process of an electromagnetic wave detection method according to an embodiment of the present disclosure.

### DESCRIPTION OF EMBODIMENTS

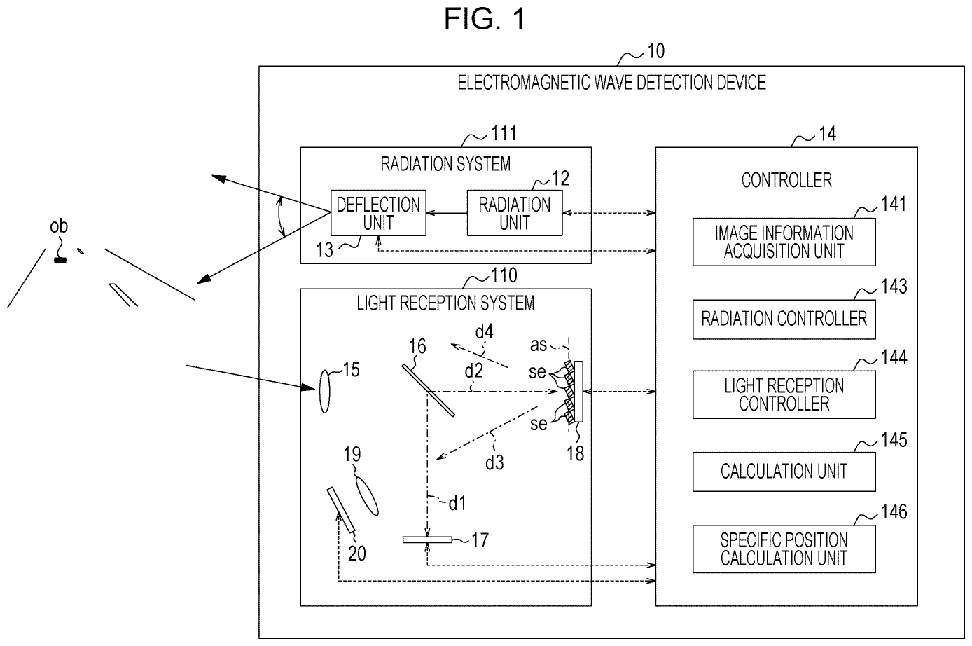

An electromagnetic wave detection device 10 (see FIG. 1), an electromagnetic wave detection method, a program, and a mobile body according to an embodiment of the present disclosure are described below with reference to the drawings. In the drawings, the same or corresponding parts are assigned the same reference symbols. In the description of this embodiment, the description of identical or equivalent parts is omitted or simplified as appropriate.

### Electromagnetic Wave Detection Device

FIG. 1 illustrates the schematic configuration of the electromagnetic wave detection device 10 according to this embodiment. The electromagnetic wave detection device 10 includes a radiation system 111, a light reception system 110, and a controller 14. In this embodiment, the electromagnetic wave detection device 10 functions as a distance measurement device. Furthermore, the electromagnetic wave detection device 10 may function as a driving assistance device that detects and warns of the presence of an object ob such as an obstacle on the road. The electromagnetic wave detection device 10 may be installed in a mobile body, such as a vehicle traveling on a road. In this embodiment, although the electromagnetic wave detection device 10 is described as including one radiation system 111 and one light reception system 110, the number of radiation systems 111 and light reception systems 110 is not limited to one. For example, the electromagnetic wave detection device 10 may be configured such that each of multiple light reception systems 110 is associated with each of multiple radiation systems 111.

The radiation system 111 includes a radiation unit 12 and a deflection unit 13. The light reception system 110 includes an incidence unit 15, a separation unit 16, a first detection unit 20, a second detection unit 17, a switching unit 18, and a latter-stage optical system 19.

The controller 14 includes an image information acquisition unit 141, a radiation controller 143, a light reception controller 144, a calculation unit 145, and a specific position calculation unit 146. Details of each functional block of the electromagnetic wave detection device 10 will be described later. In this embodiment, the first detection unit 20 and the second detection unit 17 are included in the same light reception system 110, but are not limited to this configuration. For example, the first detection unit 20 and the second detection unit 17 may be included in separate devices.

In the drawings, dashed lines connecting the functional blocks indicate the flow of control signals or communicated information. The communication indicated by the dashed lines may be wired or wireless communication. Furthermore, solid line arrows indicate electromagnetic wave beams. In the drawings, the object ob is the subject of the electromagnetic wave detection device 10. The subject may include, for example, a road, a median strip, a vehicle, or a fallen object, and may also include a person. Furthermore, the number of objects ob is not limited to one. In this embodiment, the object ob particularly includes a road (road surface).

The electromagnetic wave detection device 10 acquires an image including a subject and can identify the subject by detecting reflected waves reflected by the subject. The electromagnetic wave detection device 10 further includes a calculation unit 145 that measures the distance to the object ob, and functions as a distance measuring device as described above.

### Radiation System

The radiation system 111 radiates electromagnetic waves into the space where the object ob is located. In this embodiment, the radiation system 111 directs the electromagnetic waves radiated by the radiation unit 12 toward the space where the object ob is located via the deflection unit 13.

The radiation unit 12 radiates at least one selected from a group consisting of infrared light, visible light, ultraviolet light, and radio waves. In this embodiment, the radiation unit 12 radiates a narrow beam of electromagnetic waves. The radiation unit 12 also radiates pulsed electromagnetic waves. The radiation unit 12 may include, for example, an LED (light emitting diode) as an electromagnetic wave radiating device. The radiation unit 12 may also include, for example, an LD (laser diode) as an electromagnetic wave radiating device. The radiation unit 12 switches between radiating and stopping radiating electromagnetic waves based on control performed by the controller 14.

The deflection unit 13 allows the electromagnetic waves radiated by the radiation unit 12 to be output in multiple different directions, thereby changing the irradiation position of the electromagnetic waves radiated into the space where the object ob is present. In other words, the deflection unit 13 changes the radiation direction of the electromagnetic waves radiated by the radiation unit 12. The electromagnetic waves may be output in multiple different directions by reflecting the electromagnetic waves from the radiation unit 12 while changing the orientation of the deflection unit 13. For example, the deflection unit 13 may scan the object ob in one or two dimensions with the electromagnetic waves radiated by the radiation unit 12.

The deflection unit 13 is configured so that at least part of an irradiation area, which is the space to which the electromagnetic waves are output, is included in the electromagnetic wave detection range of the light reception system 110. Therefore, at least a portion of the electromagnetic waves radiated into the space where the object ob is present via the deflection unit 13 are reflected by at least part of the object ob and detected by the light reception system 110. Here, the electromagnetic waves resulting from the radiated waves being reflected by at least part of the object ob are referred to as reflected waves. The radiated waves are electromagnetic waves radiated from the radiation system 111 toward the space where the object ob is present in multiple directions.

The deflection unit 13 includes, for example, a MEMS (microelectromechanical systems) mirror, a polygon mirror, or a galvanometer mirror.

The deflection unit 13 changes the direction in which the electromagnetic waves are reflected based on control performed by the controller 14. The deflection unit 13 may also include an angle sensor, such as an encoder, and may notify the controller 14 of an angle detected by the angle sensor as direction information about the reflection of the electromagnetic waves. In this configuration, the controller 14 can calculate the irradiation position of the electromagnetic waves on the object ob based on the direction information obtained from the deflection unit 13. The controller 14 can also calculate the irradiation position based on a drive signal input to the deflection unit 13 to change the direction of reflection of the electromagnetic waves.

### Light Reception System

Hereinafter, “electromagnetic waves including reflected waves” refers to electromagnetic waves that include reflected waves that are reflected by the object ob and enter the light reception system 110. That is, to distinguish these electromagnetic waves from the radiated waves, electromagnetic waves that enter the light reception system 110 may be referred to as “electromagnetic waves including reflected waves”. Electromagnetic waves including reflected waves include not only reflected waves resulting from the electromagnetic waves radiated from the radiation system 111 being reflected by the object ob, but also external light such as sunlight, and external light reflected from the object ob.

The incidence unit 15 is an optical system that includes at least one optical element and forms an image of the object ob, which is the subject. The optical element includes at least one selected from a group consisting of a lens, a mirror, an aperture, an optical filter, and so on.

The separation unit 16 is provided between the incidence unit 15 and a primary image-forming position. The primary image-forming position is an image-forming position of the object ob at a predetermined position spaced away from the incidence unit 15. The separation unit 16 separates the electromagnetic waves, including the reflected waves, by wavelength, so that the electromagnetic waves propagate in a first direction d1 or a second direction d2. The separation unit 16 may separate the electromagnetic waves, including the reflected waves, into reflected waves and electromagnetic waves excluding the reflected waves. The electromagnetic waves excluding the reflected waves may include light, such as visible light.

In this embodiment, the separation unit 16 reflects a portion of the electromagnetic waves, including the reflected waves, in the first direction d1 and transmits another portion in the second direction d2. In this embodiment, the separation unit 16 reflects visible light, which is environmental light such as sunlight, reflected by the object ob, out of the incident electromagnetic waves, in the first direction d1. Furthermore, the separation unit 16 transmits, in the second direction d2, electromagnetic waves radiated by the radiation unit 12 and reflected by the object ob. The separation unit 16 may refract or transmit a portion of the incident electromagnetic waves in the first direction d1, and refract or reflect another portion of the electromagnetic waves in the second direction d2. The separation unit 16 may be, for example, a half mirror, a beam splitter, a dichroic mirror, a cold mirror, a hot mirror, a metasurface, a deflector, or a prism.

The second detection unit 17 is provided on the path of the electromagnetic waves propagating from the separation unit 16 in the first direction d1. The second detection unit 17 is provided at or near the image-forming position of the image of the object ob in the first direction d1. The second detection unit 17 detects the electromagnetic waves propagating in the first direction d1 from the separation unit 16.

Furthermore, the second detection unit 17 may be disposed relative to the separation unit 16 such that a first propagation axis of the electromagnetic waves propagating in the first direction d1 from the separation unit 16 is parallel to a first detection axis of the second detection unit 17. The first propagation axis is a central axis of the electromagnetic waves propagating from the separation unit 16 in the first direction d1 while spreading radially. In this embodiment, the first propagation axis is an axis obtained by extending the optical axis of the incidence unit 15 to the separation unit 16 and bending the axis at the separation unit 16 so as to be parallel to the first direction d1. The first detection axis is an axis that passes through the center of a detection surface of the second detection unit 17 and is perpendicular to the detection surface.

Furthermore, the second detection unit 17 may be disposed so that the distance between the first propagation axis and the first detection axis is less than or equal to a first distance threshold. Furthermore, the second detection unit 17 may be disposed so that the first propagation axis and the first detection axis coincide with each other. In this embodiment, the second detection unit 17 is disposed so that the first propagation axis and the first detection axis coincide with each other.

Furthermore, the second detection unit 17 may be disposed with respect to the separation unit 16 so that a first angle between the first propagation axis and the detection surface of the second detection unit 17 is less than or equal to a first angle threshold or a predetermined angle. In this embodiment, the second detection unit 17 is disposed so that the first angle is 90°.

In this embodiment, the second detection unit 17 is a passive sensor. More specifically, in this embodiment, the second detection unit 17 includes an element array. For example, the second detection unit 17 includes an imaging element such as an image sensor or an imaging array, and captures an image formed by electromagnetic waves on the detection surface to generate image information about the space including the captured object ob.

In this embodiment, the second detection unit 17 more specifically captures an image using visible light. The second detection unit 17 transmits the generated image information to the controller 14 as a signal. The second detection unit 17 may capture images using light other than visible light, such as infrared light or ultraviolet light.

The switching unit 18 is provided on the path of the electromagnetic waves propagating from the separation unit 16 in the second direction d2. The switching unit 18 is provided at or near the primary image-forming position of the object ob in the second direction d2.

In this embodiment, the switching unit 18 is provided at the image-forming position. The switching unit 18 has an action surface as onto which the electromagnetic waves that have passed through the incidence unit 15 and the separation unit 16 are incident. The action surface as consists of multiple switching elements se arranged two-dimensionally. The action surface as is a surface that exerts an action, such as reflection or transmission, on the electromagnetic waves in at least one of a first state and a second state described below.

The switching unit 18 can switch between a first state in which the electromagnetic waves incident on the action surface as propagate in a third direction d3 and a second state in which the electromagnetic waves propagate in a fourth direction d4 for each of the switching elements se. In this embodiment, the first state is a first reflection state in which the electromagnetic waves incident on the action surface as are reflected in the third direction d3. The second state is a second reflection state in which electromagnetic waves incident on the action surface as are reflected in the fourth direction d4.

In this embodiment, the switching unit 18 more specifically includes a reflective surface for each switching element se that reflects electromagnetic waves. The switching unit 18 switches between the first reflection state and the second reflection state in each switching element se by arbitrarily changing the orientation of each reflective surface of each switching element se.

The switching unit 18 may be, for example, a DMD (digital micromirror device). The DMD can switch the reflective surface in each switching element se to an inclined state of +12° or −12° relative to the action surface as by driving the minute reflective surfaces constituting the action surface as. The action surface as is parallel to the surface of the substrate on which the minute reflective surfaces of the DMD are mounted.

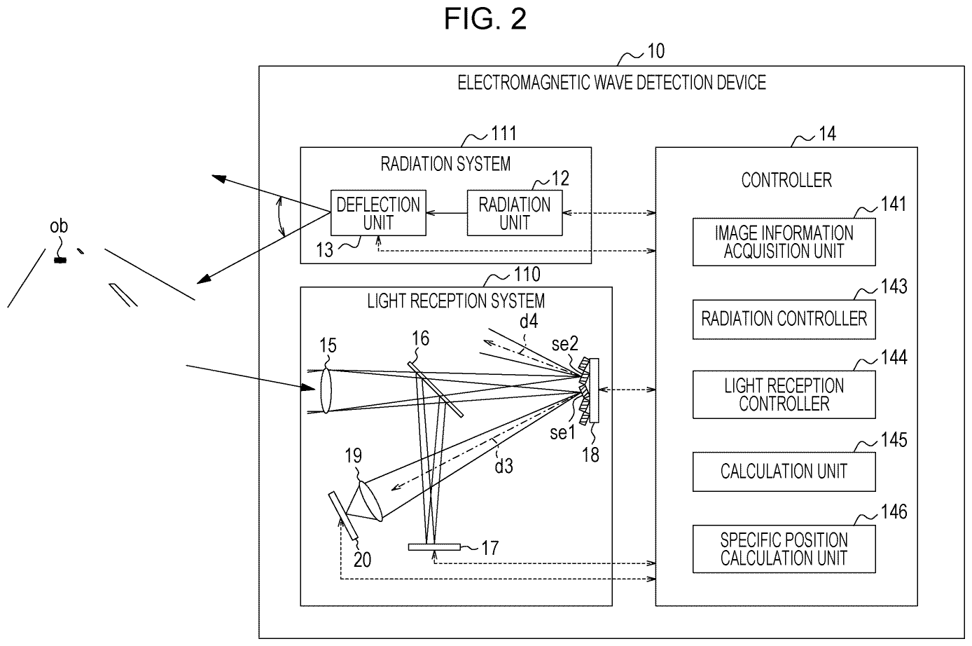

The switching unit 18 switches each switching element se between the first state and the second state based on control performed by the controller 14. For example, as illustrated in FIG. 2, the switching unit 18 can switch some switching elements se1 to the first state to cause the electromagnetic waves incident on the switching elements se1 to propagate in the third direction d3. The switching unit 18 can also simultaneously switch some other switching elements se2 to the second state to cause the electromagnetic waves incident on the switching elements se2 to propagate in the fourth direction d4. More specifically, the controller 14 detects the direction or position of the radiated electromagnetic waves based on direction information from the deflection unit 13. Then, by setting the switching elements se1 to the first state and the other switching elements se2 to the second state depending on the radiation direction or irradiation position of the detected electromagnetic waves, the reflected waves from the object ob are selectively made to propagate in the third direction d3. Out of the electromagnetic waves that have passed through the separation unit 16, the electromagnetic waves other than the reflected waves from the object ob propagate in the fourth direction d4 and are therefore not incident on the first detection unit 20.

As illustrated in FIG. 1, the latter-stage optical system 19 is disposed in the third direction d3 from the switching unit 18. The latter-stage optical system 19 includes, for example, at least one of a lens or a mirror. The latter-stage optical system 19 forms an image of the object ob as electromagnetic waves whose propagation direction has been switched by the switching unit 18.

The first detection unit 20 detects the reflected waves. The first detection unit 20 is disposed so as to be able to detect the electromagnetic waves that have propagated in the third direction d3 due to the switching unit 18 and then propagated via the latter-stage optical system 19. The first detection unit 20 detects the electromagnetic waves that have passed through the latter-stage optical system 19, i.e., the electromagnetic waves that have propagated in the third direction d3, and outputs a detection signal.

Furthermore, the first detection unit 20, together with the switching unit 18, may be disposed so that a second propagation axis of the electromagnetic waves that have propagated in the second direction d2 from the separation unit 16 and whose propagation direction has been switched to the third direction d3 by the switching unit 18 is parallel to a second detection axis of the first detection unit 20. The second propagation axis is the central axis of the electromagnetic waves that propagate in the third direction d3 from the switching unit 18 while spreading radially. In this embodiment, the second propagation axis is an axis obtained by extending the optical axis of the incidence unit 15 to the switching unit 18 and then bending the axis at the switching unit 18 so as to be parallel to the third direction d3. The second detection axis passes through the center of the detection surface of the first detection unit 20 and is perpendicular to the detection surface.

Furthermore, the first detection unit 20 may be disposed so that the distance between the second propagation axis and the second detection axis is less than or equal to a second distance threshold. The second distance threshold may be the same as or different from the first distance threshold. Furthermore, the first detection unit 20 may be disposed so that the second propagation axis and the second detection axis coincide with each other. In this embodiment, the first detection unit 20 is disposed so that the second propagation axis and the second detection axis coincide with each other.

Furthermore, the first detection unit 20 may be disposed so that a second angle formed between the second propagation axis and the detection surface of the first detection unit 20 is less than or equal to a second angle threshold or a predetermined angle. The second angle threshold may be the same as or different from the first angle threshold. In this embodiment, the first detection unit 20 is disposed so that the second angle is 90°.

In this embodiment, the first detection unit 20 is an active sensor that detects reflected waves out of electromagnetic waves radiated from the radiation unit 12 toward the object ob. The first detection unit 20 includes a single element, such as an APD (avalanche photodiode), a PD (photodiode), or a distance measurement image sensor. The first detection unit 20 may further include an element array, such as an APD array, a PD array, a distance measurement imaging array, or a distance measurement image sensor.

In this embodiment, the first detection unit 20 transmits detection information indicating the detection of reflected waves from the object to the controller 14 as a signal.

In this embodiment, the first detection unit 20 is used as a detection device for measuring the distance to the object ob. In other words, the first detection unit 20 is an element constituting a distance measurement sensor. Therefore, the first detection unit 20 does not need to be provided at a secondary image-forming position, which is the image-forming position of the latter-stage optical system 19. The first detection unit 20 may be disposed anywhere along the path of the electromagnetic waves that propagate in the third direction d3 via the switching unit 18 and then through the latter-stage optical system 19, as long as the electromagnetic waves can be incident on the detection surface from all angles of view.

With the above-described configuration, the electromagnetic wave detection device 10 aligns a predetermined position on an image with the optical axis of reflected waves used to measure the distance to that position.

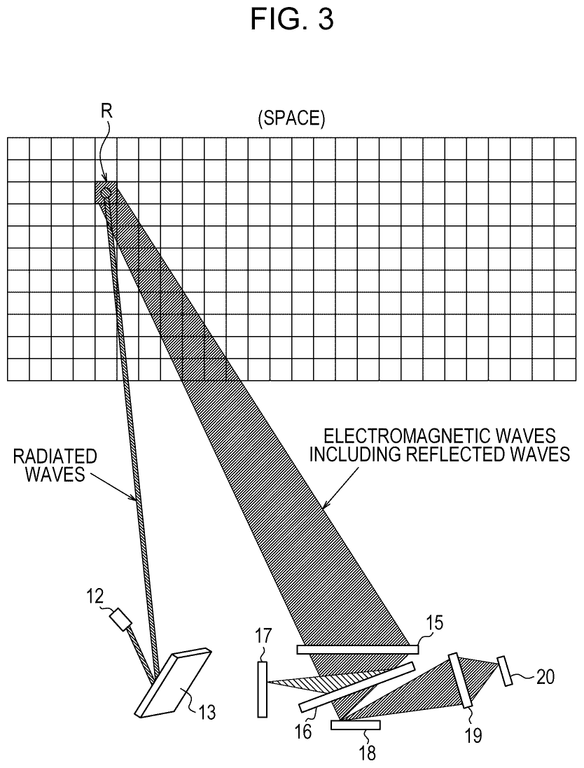

Here, FIG. 3 is a diagram for explaining the detection of electromagnetic waves including reflected waves. In FIG. 3, the space in which the object ob exists is divided into a grid-like pattern based on the number of times per frame that the radiation system 111 radiates electromagnetic waves. Generally, the time required to detect one frame of electromagnetic waves, including reflected waves, is longer than the time required to capture one frame of image using an imaging element or the like. For example, an imaging element can capture 30 frames of an image of 1920×1080 pixels per second. On the other hand, the time required to measure a distance by receiving the reflected waves from the radiated electromagnetic waves is determined according to the distance that the electromagnetic wave detection device 10 can measure, but as an example, one point may take about 20 μs (each range into which space is divided into a grid pattern in FIG. 3). Therefore, the number of points at which distance information is acquired by receiving reflected waves from the space is less than 1920×1080 per frame.

In the example in FIG. 3, a beam of electromagnetic waves radiated from the radiation unit 12 is reflected by the deflection unit 13 and enters a single region R in the space as radiated waves. The radiated waves are, for example, infrared light. Electromagnetic waves (e.g., infrared light) including reflected waves reflected by the object ob present in the region R are incident on the incidence unit 15. The electromagnetic waves including reflected waves also include visible light resulting from external light being reflected by the object ob present in the region R. The separation unit 16 reflects the visible light from the electromagnetic waves including reflected waves in the first direction d1. The reflected visible light is detected by the second detection unit 17. The separation unit 16 also transmits infrared light from the electromagnetic waves including reflected waves in the second direction d2. The infrared light transmitted through the separation unit 16 is reflected by the switching unit 18, and at least a portion of the infrared light propagates in the third direction d3. The infrared light propagating in the third direction d3 passes through the latter-stage optical system 19 and is detected by the first detection unit 20.

In the following description, each area of the grid-like pattern in FIG. 3 (referred to as points above) is referred to as a LiDAR pixel. In other words, a LiDAR pixel is the smallest unit of multiple pieces of distance information acquired from the reflected waves of electromagnetic waves radiated multiple times per frame. In the case where the electromagnetic wave detection device 10 is a scanning LiDAR using a DMD as the switching unit 18, one area in which a DMD micromirror deflects electromagnetic waves toward the first detection unit 20 corresponds to one LiDAR pixel. In the case of a scanning LiDAR electromagnetic wave detection device 10 not using a DMD, one position at which a distance is acquired corresponds to one LiDAR pixel. Alternatively, the electromagnetic wave detection device 10 may be a flash LiDAR that emits electromagnetic waves in a diffuse manner. In the case where the electromagnetic wave detection device 10 is a flash LiDAR, one LiDAR pixel corresponds to the area irradiated with radiated light corresponding to reflected light made incident to obtain a depth (D).

### Controller

The radiation controller 143 controls the radiation system 111. The radiation controller 143, for example, causes the radiation unit 12 to switch between radiating electromagnetic waves and stopping radiating electromagnetic waves. The radiation controller 143, for example, causes the deflection unit 13 to change the direction in which the electromagnetic waves are reflected.

In this embodiment, the radiation unit 12 of the radiation system 111 radiates electromagnetic waves in multiple different directions via the deflection unit 13. The electromagnetic waves are radiated in a certain direction at a certain timing, and the irradiated area (irradiation area) in this case may be referred to as a first area. The first area is an irradiation area corresponding to a single LiDAR pixel. In this embodiment, the radiation unit 12 irradiates an area including the first area with electromagnetic waves.

The image information acquisition unit 141 acquires image information of the area including the first area from the second detection unit 17. The image information is, for example, an image in which the luminance value of each pixel is detected, and includes color images (RGB images) and monochrome images.

The light reception controller 144 controls the light reception system 110. The light reception controller 144, for example, causes the switching unit 18 to switch each switching element se between the first state and the second state.

The calculation unit 145 calculates the distance to the object ob based on the detection information from the first detection unit 20. That is, the first detection unit 20 detects reflected waves resulting from electromagnetic waves being reflected by the first area. The calculation unit 145 acquires the detection information from the first detection unit 20 and calculates the distance to the object ob in the first area. The object ob includes the road surface in the first area. The calculation unit 145 can calculate the distance based on the acquired detection information using, for example, a ToF (time-of-flight) method.

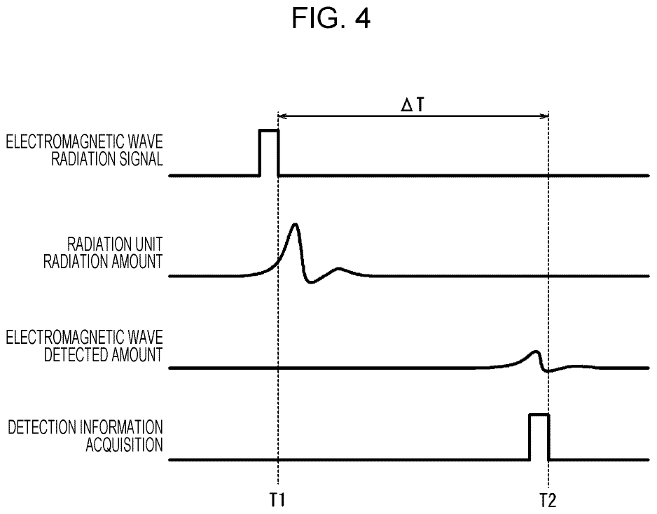

As illustrated in FIG. 4, the controller 14 inputs an electromagnetic wave radiation signal to the radiation unit 12, thereby causing the radiation unit 12 to radiate pulsed electromagnetic waves (see the “electromagnetic wave radiation signal” section). The radiation unit 12 radiates electromagnetic waves based on the input electromagnetic wave radiation signal (see the “radiation unit radiation amount” section). The electromagnetic waves radiated by the radiation unit 12 and reflected by the deflection unit 13 onto the irradiation area, which is the space where the object ob is located, are reflected in the irradiation area. The controller 14 switches at least some of the switching elements se in the image-forming area of the switching unit 18 for the reflected waves from the irradiation area to the first state in advance, and switches the other switching elements se to the second state. Then, when the first detection unit 20 detects electromagnetic waves reflected in the irradiation area (see the “electromagnetic wave detected amount” section), the first detection unit 20 notifies the controller 14 of the detection information.

The calculation unit 145 acquires the above signal information, including the detection information. The calculation unit 145 includes, for example, a time measurement LSI (large scale integrated circuit) and measures a time ΔT from a time T1 when the radiation unit 12 radiated the electromagnetic waves to a time T2 at which the detection information was acquired (see the “detection information acquisition” section). The calculation unit 145 calculates the distance to the irradiation position by multiplying the time ΔT by the speed of light and dividing by 2.

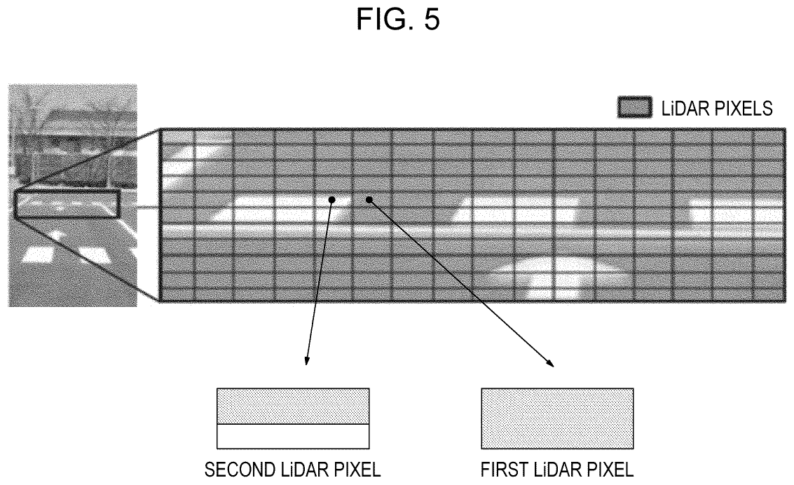

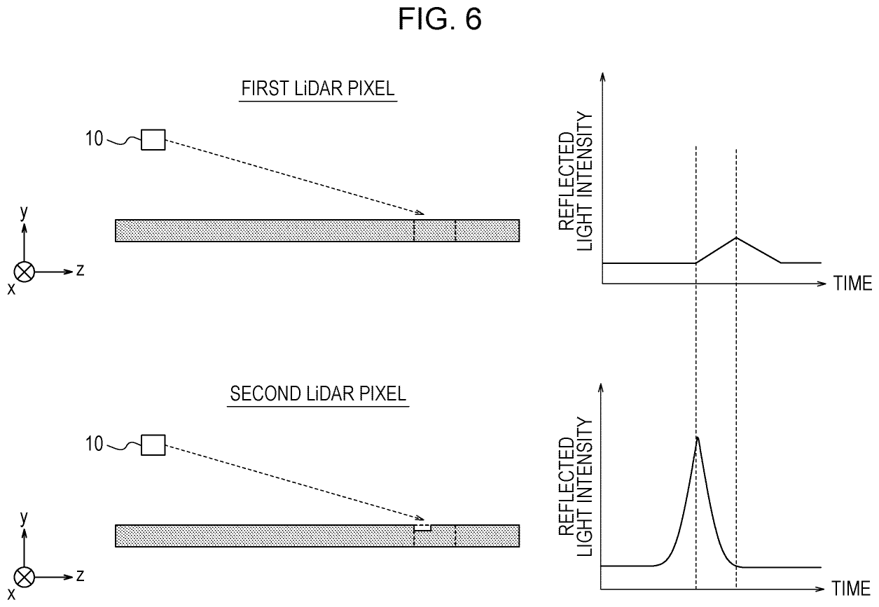

As illustrated in FIG. 5, an irradiation area corresponding to one LiDAR pixel may contain multiple areas with different reflectances. That is, the first area may contain factors that affect the reflectance of the electromagnetic waves. An example of a factor that affects the reflectance of the electromagnetic waves is the presence of an element with a reflectance that differs from the reflectance of the majority of the irradiation area. In the example in FIG. 5, a white line drawn on the road surface and the road surface have different reflectances for electromagnetic waves. The irradiation area corresponding to a first LiDAR pixel has an almost uniform gray color throughout. In contrast, the irradiation area corresponding to a second LiDAR pixel is white due to the presence of a white line in the foreground, and the area behind the white line is gray. Although the distance to the position of the first LiDAR pixel and the distance to the position of the second LiDAR pixel are approximately the same, there may be a difference between the distances calculated by the calculation unit 145. As illustrated in FIG. 6, the peak of the reflected light intensity (corresponding to the electromagnetic wave detected amount in FIG. 4) at the first LiDAR pixel, which has approximately the same reflectance throughout, is used as the reference time for acquisition of the reflected light. The horizontal axis indicates the time after radiation of the electromagnetic waves. Because the reflected light intensity of the white line in the foreground is high at the second LiDAR pixel, the peak of the reflected light intensity occurs at a timing that is shifted from the reference. Therefore, even though the distances are approximately the same, the distance calculated for the second LiDAR pixel is calculated as being different from that for the first LiDAR pixel (shorter in the example in FIG. 6). In this case, if the electromagnetic wave detection device 10 generates a 3D map using the distances calculated by the electromagnetic wave detection device 10 as the distances to the centers of the irradiation areas corresponding to LiDAR pixels, the road surface will be mapped so as to be shifted upward in the second LiDAR pixel. In other words, an incorrect 3D map will be generated, in which part of the road surface protrudes in the vertical direction even though the road surface is flat. Generating an accurate 3D map is particularly important when the electromagnetic wave detection device 10 functions as a driving assistance device to detect obstacles, etc.

Based on the luminance information in the image, the specific position calculation unit 146 calculates the correct position, i.e., the specific position in the first area corresponding to the distance calculated by the calculation unit 145, when there is a factor affecting the reflectance of the electromagnetic waves in the first area. The specific position is calculated based on the distance to the first area calculated based on the detected reflected waves, the direction to the first area, and the factor affecting the reflectance of the electromagnetic waves in the first area. The processing performed by the specific position calculation unit 146 to calculate the specific position is referred to as specific position calculation processing. In addition to the specific position calculation processing, the specific position calculation unit 146 may also have the function of generating a 3D map based on the calculated specific position. The 3D map may be used to detect obstacles, etc., as described above, or may be output to a display device of the vehicle and used by passengers to check the road ahead.

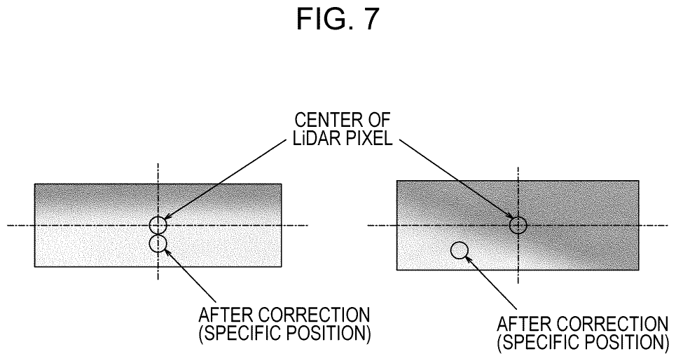

The specific position calculation processing is described in detail below. The reason for the difference in distance arising from the effect of an area having a higher reflectance is that the calculation is performed assuming that the calculated distance is the distance to the position of the center of the area corresponding to the LiDAR pixel. In other words, since the radiation direction of the beam directed by the deflection unit 13 is aligned with the position of the center of the area corresponding to the LiDAR pixel, the distance calculated by the calculation unit 145 is treated as the distance to the center of the first area in the direction in which the electromagnetic waves are radiated. Therefore, if there is a factor in the first area that affects the reflectance of the electromagnetic waves and the peak of the reflected light intensity used to calculate the distance is shifted from the center of the first area, the calculated distance will be inaccurate. As illustrated in FIG. 7, the specific position calculation processing corrects the position corresponding to the distance calculated by the calculation unit 145 from the center position of the first area (the center of the region corresponding to the LiDAR pixel) to the correct position (specific position) corresponding to the calculated distance. Here, the specific position may be a position in the space or object ob to which the electromagnetic waves are radiated, corresponding to the luminance centroid of the image of the region corresponding to the LiDAR pixel.

The specific position calculation unit 146 acquires the distance to the first area from the calculation unit 145. The specific position calculation unit 146 may acquire direction information about the radiation of the electromagnetic waves from the deflection unit 13 or information about control of the radiation direction of the electromagnetic waves from the radiation controller 143 to identify the direction to the first area. As described above, this direction corresponds to the direction to the center position of the first area. The specific position calculation unit 146 may also acquire an image of a region including the first area from the image information acquisition unit 141 and identify factors affecting the reflectance of the electromagnetic waves in the first area. That is, the specific position calculation unit 146 may extract factors that affect the reflectance of electromagnetic waves from the image information. In this embodiment, a factor that affects the reflectance of electromagnetic waves are identified based on the presence of pixels with different luminances in the image of the first area, but are not limited to luminance. As another example, a factor that affects the reflectance of electromagnetic waves may be identified based on the presence of pixels of a specific color (e.g., red) in the image. In this embodiment, the specific position calculation unit 146 calculates the position corresponding to the luminance centroid in the first area as the specific position. Binarization or multi-value processing may be performed to identify higher luminance areas. Information regarding the reflectance of electromagnetic waves for each object color or object type may be stored in advance in a storage medium accessible by the controller. If the radiation unit is configured to radiate electromagnetic waves of multiple different wavelengths, the information regarding the reflectance of electromagnetic waves stored in the storage medium may be stored for each of the multiple wavelengths that the radiation unit can radiate.

The method used by the specific position calculation unit 146 to calculate the direction of the specific position is described below. In this embodiment, the angular range of the first area corresponding to the LiDAR pixel is known. Here, the angular range of the first area may be the spread angle of the portion of the electromagnetic wave beam radiated onto the first area, which spreads in the vertical and horizontal directions, and used to measure the distance to the object ob. If all the reflected waves of the electromagnetic wave beam radiated to the first area are used to measure the distance to the first area, the angular range of the first area may be the spread angle of the beam.

Here, when a portion of the reflected waves of the electromagnetic wave beam radiated onto the first area is used to measure the distance to the first area, the electromagnetic wave detection device 10 may take the angular range of the first area to be the spread angle of the beam. For example, the electromagnetic wave detection device 10 may use a portion of the reflected waves incident on the action surface as to measure the distance to the first area by selecting a switching elements se1 that are in the first reflection state, out of the switching elements se1 of the switching unit 18. In this case, the spread angle of the portion of the electromagnetic wave beam radiated onto the first area corresponding to the portion of the reflected waves may be the angular range of the first area.

To calculate the direction of the specific position, the specific position calculation unit 146 calculates the difference in the x and y directions (i.e., the vertical and horizontal directions in the image) between the center position in the image of the first area corresponding to the LiDAR pixel and the position of the luminance centroid. The specific position calculation unit 146 calculates a correction amount to be used to correct the beam radiation direction (radiation angle) based on the angular range of the first area corresponding to the LiDAR pixel and the difference between the center position in the image of the first area corresponding to one LiDAR pixel and the position of the luminance centroid. The specific position calculation unit 146 uses this correction amount to correct the radiation direction of the electromagnetic waves indicated by the direction information to the direction of the specific position.

More specifically, a case will be described in which the range of the image of the first area corresponding to a LiDAR pixel is an area that extends 0.4° in the left-right direction and 0.1° in the up-down direction as seen from the electromagnetic wave detection device 10, and the luminance centroid is shifted 25% to the right and downward from the center position of the image. In this case, the correction amount is an angle corresponding to this shift. Therefore, the direction of the specific position is shifted 0.1° to the right and 0.025° downward from the radiation direction of the electromagnetic waves indicated by the direction information (i.e., the center of the first area).

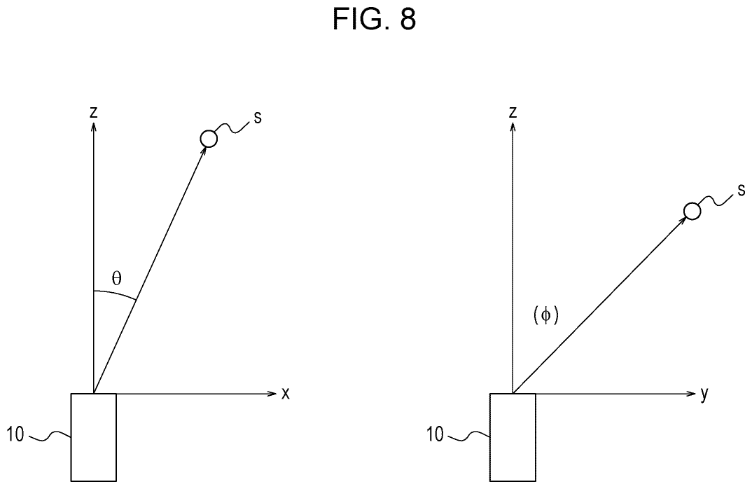

The specific position calculation unit 146 may calculate the coordinates of the specific position using spherical coordinates. In the example in FIG. 8, the z-axis direction corresponds to the traveling direction of a mobile body in which the electromagnetic wave detection device 10 is installed. The y-axis direction corresponds to the height direction of the mobile body. The x-axis direction corresponds to the left-right direction (width direction) of the mobile body. The specific position calculation unit 146 sets the position of the electromagnetic wave detection device 10 as the origin and determines the distance to a specific position(s). The distance to the first area acquired from the calculation unit 145 can be used as the distance to the specific position. The specific position calculation unit 146 determines an angle θ between the radius vector to the specific position and the z-axis. The specific position calculation unit 146 also determines an angle φ between a projection of the radius vector to the specific position onto the xy plane and the x-axis. The angles θ and φ are angles indicating the direction obtained by the specific position calculation unit 146 correcting the radiation direction of the electromagnetic waves indicated by the direction information using a correction value. Here, the specific position calculation unit 146 may convert the spherical coordinates of the specific position into three-dimensional Cartesian coordinates in the following way. The specific position calculation unit 146 may calculate the x-coordinate as R sin θ cos φ, where R is the distance to the specific position. The specific position calculation unit 146 may calculate the y-coordinate as R sin θ sin φ. The specific position calculation unit 146 may also calculate the z coordinate using R cos θ.

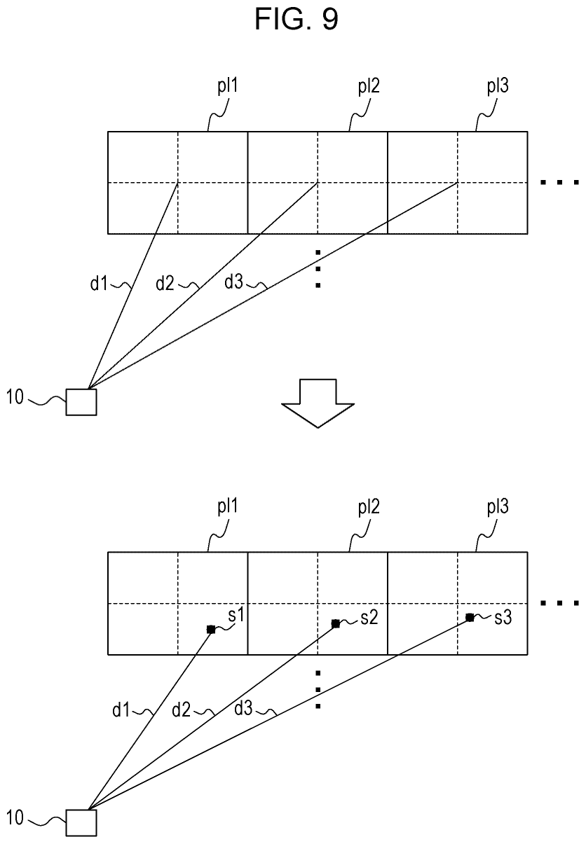

FIG. 9 is a conceptual diagram of correction performed for each LiDAR pixel. For each LiDAR pixel (pl1, pl2, pl3), the specific position calculation unit 146 calculates the coordinates (s1, s2, s3) of the specific positions respectively corresponding to the calculated distances (d1, d2, d3). The specific position calculation unit 146 may perform specific position calculation processing for all LiDAR pixels.

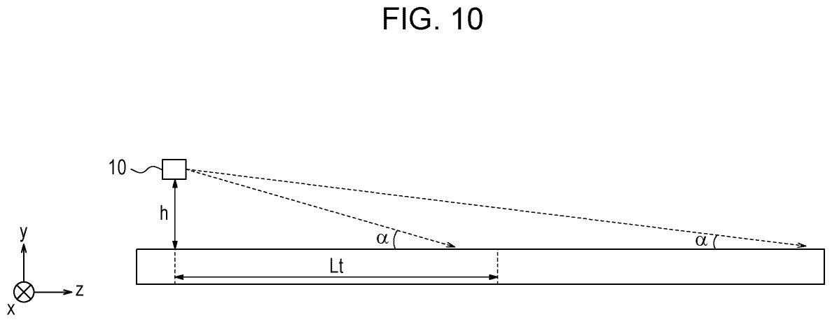

Note that a deviation in distance caused by the effect of an area with higher reflectance has a greater effect the farther away the object is. For example, if the left-right spread angle of the electromagnetic waves radiated toward the object ob is 0.3°, the spread of the irradiation area at a distance of 100 m corresponds to approximately 40 cm. Furthermore, if the height spread angle of the electromagnetic waves radiated toward the object ob is 0.1°, the spread of the irradiation area at a distance of 100 m corresponds to approximately 10 cm. Therefore, deviations in distance at distant locations are preferably appropriately corrected by the specific position calculation processing. In contrast, deviations in distance due to the effect of areas with high reflectance at adequately close distances are on the order of several centimeters and can be treated as errors. Therefore, as illustrated in FIG. 10, a predetermined distance (Lt) may be set as a distance threshold. The specific position calculation unit 146 may execute the specific position calculation processing if the distance to the first area is greater than or equal to the predetermined distance. In other words, the specific position calculation unit 146 may not execute the specific position calculation processing if the distance to the first area is less than the predetermined distance. The predetermined distance may be 30 m, for example. By executing the specific position calculation processing in accordance with an execution condition in this way, the computational load on the controller 14 can be reduced compared to when the specific position calculation processing is executed uniformly.

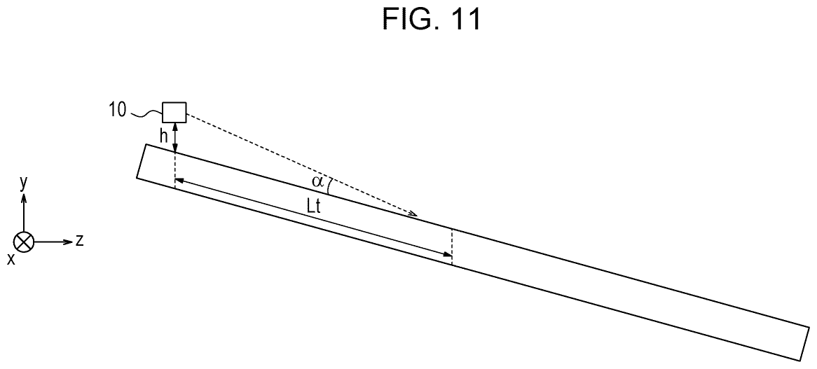

Here, the execution condition can be determined using an incidence angle (α) with respect to the first area. For example, as illustrated in FIG. 11, if an installation position (h) of the electromagnetic wave detection device 10 is low or the road is inclined etc., the incidence angle (α) may be small even when the first area is located at less than the predetermined distance (Lt). That is, the incidence angle (α) may be small, as in the case of the example in FIG. 10 where the first area is located far away. Therefore, using an execution condition for the incidence angle (α) is more preferable. The specific position calculation unit 146 may execute the specific position calculation processing if the incidence angle (α) with respect to the first area is less than a predetermined angle. In other words, the specific position calculation unit 146 may not execute the specific position calculation processing if the incidence angle (α) with respect to the first area is greater than or equal to the predetermined angle. The predetermined angle may be 10°, for example. Here, information on whether the road is inclined may be obtained using map information, for example.

The controller 14 may control the timing of the radiation of electromagnetic waves by the radiation unit 12 based on image information of the space including the object ob captured by the second detection unit 17 so as not to radiate electromagnetic waves onto an area including multiple locations with different reflectances. Specifically, the controller 14 may control the radiation of electromagnetic waves so as not to radiate electromagnetic waves onto an area in the first area where a white line and the road surface both appear.

The controller 14 may control the intensity of the electromagnetic waves radiated by the radiation unit 12 based on the proportions of areas with different reflectances for the electromagnetic waves included in the area to be radiated based on image information of the space including the object ob captured by the second detection unit 17. Specifically, the controller 14 may control the intensity of the radiated electromagnetic waves so that the intensity increases as the size of area corresponding to the road surface relative to the size of the area corresponding to the white line included in the first area increases.

Here, the controller 14 may include one or more processors. The processor may load programs from an accessible memory and operate as the image information acquisition unit 141, the radiation controller 143, the light reception controller 144, the calculation unit 145, and the specific position calculation unit 146. Such processors may include at least either of a general-purpose processor into which specific programs are loaded in order to perform specific functions and a dedicated processor dedicated to specific processing. The dedicated processor may include an application-specific integrated circuit (ASIC). The processor may include a programmable logic device (PLD). PLDs may include FPGAs (field-programmable gate arrays). The controller 14 may include at least one of a SoC (system-on-a-chip) or a SiP (system-in-a-package) in which one or more processors work together.

### Electromagnetic Wave Detection Method

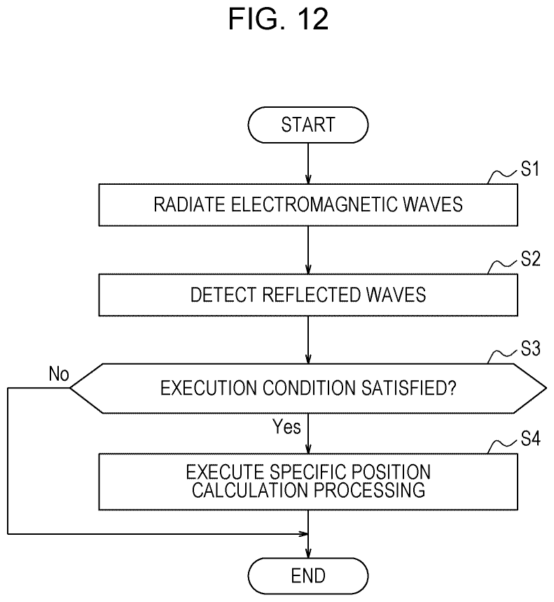

The electromagnetic wave detection device 10 executes the processing of the electromagnetic wave detection method according to this embodiment, for example, according to the flowchart illustrated in FIG. 12. The processing illustrated in FIG. 12 is performed for one LiDAR pixel. The processing illustrated in FIG. 12 may be performed for each of all of the LiDAR pixels.

The radiation unit 12 irradiates an area including the first area with electromagnetic waves (Step S1).

The first detection unit 20 detects reflected waves resulting from the electromagnetic waves being reflected by the first area (Step S2).

The controller 14 determines whether an execution condition for the specific position calculation processing is satisfied (Step S3). The execution condition may be that the distance to the first area is greater than or equal to a predetermined distance, as described above. Alternatively, the execution condition may be that the incidence angle with respect to the first area is less than a predetermined angle, as described above.

If the execution condition is satisfied (Yes in Step S3), the controller 14 executes the specific position calculation processing (Step S4). After the specific position calculation processing has been executed, or if the execution condition is not satisfied (No in Step S3), the series of processing ends.

As described above, the electromagnetic wave detection device 10, electromagnetic wave detection method, program, and mobile body according to this embodiment can calculate a specific position corresponding to distance information using the above-described configuration. Therefore, accurate 3D maps and the like can be generated based on the calculated distance information.

### Variations

The present disclosure has been described based on the drawings and examples, but note that a variety of variations and amendments may be easily made by one skilled in the art based on the present disclosure. Therefore, please note that such variations and amendments are to be included within the scope of the present disclosure.

In the above-described embodiment, the electromagnetic wave detection device 10 is configured to generate distance information using Direct ToF by radiating laser light and directly measuring the time taken for the waves to return. However, the electromagnetic wave detection device 10 is not limited to this configuration. For example, the electromagnetic wave detection device 10 may generate distance information using Flash ToF by radiating electromagnetic waves radially (i.e., simultaneously in multiple directions) at a constant frequency and indirectly measuring the time taken for the waves to return from the phase difference between the radiated electromagnetic waves and the returned electromagnetic waves. The electromagnetic wave detection device 10 may also generate distance information using other ToF methods, such as Phased ToF.

In the above embodiment, the switching unit 18 can switch the propagation direction of the electromagnetic waves incident on the action surface as between two directions, but may be capable of switching between three or more directions.

In the above embodiment, the first state and the second state of the switching unit 18 are a first reflection state in which the electromagnetic waves incident on the action surface as are reflected in the third direction d3 and a second reflection state in which the electromagnetic waves are reflected in the fourth direction d4, respectively. However, other states may also be used. For example, the first state may be a transmission state in which the electromagnetic waves incident on the action surface as are allowed to pass therethrough and propagate in the third direction d3.

In the above embodiment, the electromagnetic wave detection device 10 has a configuration in which the second detection unit 17 is a passive sensor and the first detection unit 20 is an active sensor. However, the electromagnetic wave detection device 10 is not limited to this configuration. For example, similar effects to those of the above embodiment can be achieved in the electromagnetic wave detection device 10 even with a configuration in which the second detection unit 17 and the first detection unit 20 are both active sensors or passive sensors.

In the above embodiment, the electromagnetic wave detection device 10 aligns a predetermined position on an image with the optical axis of the reflected waves used to measure the distance to that position. However, the optical axis does not need to be aligned as long as the predetermined position on the image and the irradiation range of the electromagnetic waves radiated to obtain the reflected waves used to measure the distance to that position have been associated with each other in advance.

In this embodiment, a white line painted on a road is used as an example of a factor affecting the reflectance of electromagnetic waves. However, such factors are not limited to this example, and various objects present in the first area where the electromagnetic waves are radiated can also be considered. For example, paint with characters or drawings in the first area, objects composed of metal, glass, or the like present in the first area, and puddles or ice present in the first area can be considered as factors affecting the reflectance of electromagnetic waves. In addition, the first area is not limited to a road surface, and may be a region of any object, such as an obstacle, a guardrail, or a wall.

In this embodiment, pixel luminance or color is used as an example of a method for identifying factors affecting the reflectance of electromagnetic waves from an image of an area including the first area. However, the method is not limited to this example, and various other methods are conceivable. For example, object recognition may be performed on an image of an area including the first area in order to identify objects that are present and obtain the reflectances of the objects. The typical reflectances of objects may be stored in advance on a storage medium accessible by the controller.

In this embodiment, a case in which the electromagnetic wave detection device 10 is installed in a vehicle is described as an example of a mobile body in which the electromagnetic wave detection device 10 is installed, but the present disclosure is not limited to this example. Devices in which the electromagnetic wave detection device 10 may be installed include aircraft, ships, trains, motorcycles, bicycles, AGVs (automated guided vehicles), AMRs (autonomous guided robots), picking robots, general-purpose robots, and so on.

When the electromagnetic wave detection device 10 is installed in an aircraft, the present disclosure can be applied to measuring the distance to the runway along which the aircraft travels (used for takeoff and landing). Objects with different electromagnetic wave reflectances than the runway surface, such as embedded lights, runway signs, and guidance markings, may be present on the runway surface. When such objects are included in the first area, the electromagnetic wave detection device 10, electromagnetic wave detection method, program, and mobile body according to this embodiment can calculate a specific position corresponding to the distance information. Therefore, accurate 3D maps and the like can be generated based on the calculated distance information.

When the electromagnetic wave detection device 10 is installed on a ship, the present disclosure can be applied to measuring the distance to a quay when docking, measuring the distance to other ships, etc. Bumpers, mooring ropes, mooring rings, and so on may be present on the quay where the ship docks. The bumpers may have a lower electromagnetic wave reflectance than concrete portions of the quay. The mooring rings may have a higher electromagnetic wave reflectance than the concrete portions of the quay. When such objects are included in the first area, the electromagnetic wave detection device 10, electromagnetic wave detection method, program, and mobile body according to this embodiment can calculate a specific position corresponding to the distance information. Furthermore, because a mooring rope connects the ship to a mooring ring on a quay, the distance to the ship may be sometimes much shorter than the distance to the quay. If a mooring rope is included in the first area, accurate distance information may not be obtained. The controller 14 may control the timing at which electromagnetic waves are radiated by the radiation unit 12 based on image information of the space including the object ob captured by the second detection unit 17 so as not to radiate electromagnetic waves to an area including a mooring rope.

When the electromagnetic wave detection device 10 is installed in a railway vehicle, the present disclosure can be applied to measuring the distance to the tracks on which the vehicle is traveling or the surrounding area.

When the electromagnetic wave detection device 10 is installed in a motorcycle, a bicycle, or the like, the present disclosure can be applied to measuring distances to roads and sidewalks on which the vehicle is traveling.

When the electromagnetic wave detection device 10 is installed in an AGV or AMR, the present disclosure can be applied to measuring distances to the road surface on which the vehicle is traveling.

When the electromagnetic wave detection device 10 is installed in a picking robot or general-purpose robot, the present disclosure can be applied to measuring distances to a workpiece to be picked up, a road surface on which workpieces are piled up, or a container. For example, if the workpiece is a component composed of a combination of different materials, a first area on the workpiece irradiated with electromagnetic waves by the electromagnetic wave detection device 10 may contain multiple different substances. Using the electromagnetic wave detection device 10, electromagnetic wave detection method, program, and mobile body according to this embodiment, a specific position corresponding to distance information can be calculated. Alternatively, the controller 14 may control the timing at which electromagnetic waves are radiated by the radiation unit 12 based on image information of the space including the object ob captured by the second detection unit 17 so as not to irradiate areas on the workpiece where different substances are exposed with electromagnetic waves.

In this embodiment, a case in which the electromagnetic wave detection device 10 is installed in a mobile body has been described as an example, but the present disclosure is not limited to this example. The electromagnetic wave detection device 10 may be installed in a surveillance device, a roadside device, or the like.

When the electromagnetic wave detection device 10 is installed in a surveillance device, the present disclosure can be applied to measuring distances to monitoring targets in the surrounding area, both indoors and outdoors. Here, the monitoring targets are not limited to road surfaces such as outdoor roads, sidewalks, quays, railroad tracks, railroad crossings, or runways, or indoor passageways, or the floor surfaces of rooms, and may also include mobile bodies, people, animals, or substances provided in the surrounding area.

When the electromagnetic wave detection device 10 is installed in a roadside device provided at the side of a road, the present disclosure can be applied to measuring distances to road surfaces in the surrounding area, such as roads and sidewalks, on which mobile bodies, pedestrians, etc. can move.

While the solution of the present disclosure has been described in the form of a device and a method, the present disclosure can also be realized in other embodiments including these forms. The present disclosure may also be realized as a storage medium on which a program substantially equivalent to the device or the method is recorded, and please understood that such a storage medium and program are also included within the scope of the present disclosure.

### REFERENCE SIGNS

10 Electromagnetic Wave Detection Device
12 radiation unit
13 deflection unit
14 controller
15 incidence unit
16 separation unit
17 second detection unit
18, 181 switching unit
19 latter-stage optical system
20 first detection unit
60 spatial image
61 image of first area
110 light reception system
111 radiation system
141 image information acquisition unit
143 radiation controller
144 light reception controller
145 calculation unit
146 specific position calculation unit
as action surface
d1, d2, d3, d4 first direction, second direction, third direction, fourth direction
ob object

1. An electromagnetic wave detection device comprising:
a radiation unit configured to output electromagnetic waves to be radiated onto an area including a first area;
a first detection unit configured to detect reflected waves resulting from the electromagnetic waves being reflected by the first area; and
a controller configured to execute specific position calculation processing to, based on a distance acquired based on the detected reflected waves, a direction in which the electromagnetic waves are radiated, and a factor affecting a reflectance of the electromagnetic waves in the first area, calculate a specific position in the first area corresponding to the distance.

2. The electromagnetic wave detection device according to claim 1, further comprising:
a deflection unit configured to change a radiation direction of the electromagnetic waves output by the radiation unit.

3. The electromagnetic wave detection device according to claim 1, further comprising:
a second detection unit configured to capture an image of the area including the first area,
wherein the controller acquires a factor affecting a reflectance of the electromagnetic waves from the captured image of the first area.

4. The electromagnetic wave detection device according to claim 3,
wherein the controller acquires the factor affecting the reflectance of the electromagnetic waves based on luminance information in the image of the first area.

5. The electromagnetic wave detection device according to claim 4,
wherein the controller calculates the specific position based on a center position in the image of the first area and a position of a luminance centroid of the image.

6. The electromagnetic wave detection device according to claim 1,
wherein the factor affecting the reflectance of the electromagnetic waves is a presence of areas in the first area with different reflectances for the electromagnetic waves.

7. The electromagnetic wave detection device according to claim 1,
wherein the specific position calculation processing is executed when a distance to the first area is greater than or equal to a predetermined distance.

8. The electromagnetic wave detection device according to claim 1,
wherein the specific position calculation processing is executed when an incidence angle with respect to the first area is less than a predetermined angle.

9. An electromagnetic wave detection device comprising:
a radiation unit configured to output electromagnetic waves to be radiated onto an area including a first area;
a first detection unit configured to detect reflected waves resulting from the electromagnetic waves being reflected by the first area; and
a controller configured to execute specific position calculation processing to, based on a distance to the first area acquired based on the detected reflected waves, a direction in which the electromagnetic waves are radiated, and a color of an object present in the first area, calculate a specific position in the first area corresponding to the distance.

10. An electromagnetic wave detection device comprising:
a radiation unit configured to output electromagnetic waves to be radiated onto an area including a first area;
a first detection unit configured to detect reflected waves resulting from the electromagnetic waves being reflected by the first area; and
a controller configured to execute specific position calculation processing to, based on a distance to the first area acquired based on the detected reflected waves, a direction in which the electromagnetic waves are radiated, and a reflectance of an object present in the first area, calculate a specific position in the first area corresponding to the distance.

11. (canceled)

12. (canceled)

13. (canceled)

14. (canceled)

15. A mobile body comprising:
the electromagnetic wave detection device according to claim 1 installed therein.

16. The mobile body according to claim 15,
wherein the mobile body is a vehicle, and
the first area is a portion of a road or road surface on which the vehicle travels.

17. The mobile body according to claim 15,
wherein the mobile body is a ship, and
the first area is a portion of a quay where the ship docks.

18. (canceled)

19. (canceled)
